(19) United States
(12) Patent Application Publication
(10) Pub. No.: US 2010/0276651 A1
(43) Pub. Date: Nov. 4, 2010

(54) Method and apparatus for leveling travel trailers

(76) Inventor: David E. Fought, Middlebury, IN (US)

Correspondence Address: BARNES & THORNBURG LLP, P.O. BOX 2786, CHICAGO, IL, 60690-2786, US

(21) Appl. No.: 12/800,369

(22) Filed: May 5, 2009

Related U.S. Application Data
(63) Continuation-in-part of application No. 29/308,340, filed on Jun. 12, 2008.

(51) Int. Cl. B66F 7/12

(52) U.S. Cl. 254/89 R

(57) ABSTRACT

A method and apparatus for leveling travel trailers is provided by placing a first pair of remotely operable jacks at the lower front corners of the trailer, placing a left and right pair of remotely operable jacks on each side of the trailer close to the axle hangers, mounting front to back and side to side level sensor on the trailer, and then operating the first pair of jacks to elevate the trailer when disconnecting the trailer from the towing vehicle and establishing a front to back level status by reference to the sensor output and then operating the left and/or right pair of jacks to establish a side to side level status by reference to the sensor output.

This application is a continuation-in-part of prior U.S. patent application Ser. No. 29/308,340, filed on Jun. 12, 2008, by the same applicant and incorporates by reference all of the disclosure of that prior application.

### BACKGROUND, OBJECTIVES, AND SUMMARY OF THE INVENTION

The present invention relates to travel trailers and, more particularly, to methods of leveling travel trailers once they are parked for occupation. The prior application referenced above shows an ornamental design for application of the present invention to a fifth wheel type of travel trailer. The present application discloses the process and function of using leveling jacks for travel trailers in general.

Byway of background, travel trailers are towed vehicles having a living compartment therein which is usually intended for temporary housing. Travel trailers can incorporate cargo compartments interiorly or exteriorly on the same vehicle frame. Such travel trailers may be referred to within the industry by a variety of names, such as toy haulers, sport utility trailers, horse trailers, snow mobile trailers, and/or hybrid trailers. Travel trailers can also include fold out or slide out rooms which are closed while the trailer is being transported and opened while the vehicle is park and ready for use so as to expand the usable interior space of the trailer. Travel trailers can also include permanently formed extensions from the trailer body which overhang the towing vehicle while the trailers is being towed. These latter type of travel trailers are usually called fifth wheels or fifth wheel trailers.

In terms of general manufacturing trends, travel trailers have tended to be made to maximize the interior living space available when the trailer is parked (up to the limits permitted by various regulations) while at the same time limiting the trailer “footprint” when being towed. Also, travel trailers are often intended to be made as light weight as reasonably possible so as to facilitate the towing operation by a variety of vehicles as well as to reduce the cost of both manufacture and the cost of towing (as, for example, by increasing fuel economy). Since travel trailers are not usually intended to be occupied while being towed, various regulations do not require travel trailers to have, for example, the same heavy and structurally rigid frames as are found in other recreational vehicles, such as motor homes.

In use, travel trailers are typically detached from the towing vehicle and free standing. In its simplest form, a travel trailer is supported on the ground by the wheels (usually a pair mounted on a single axle intermediate the front-to-back length of the trailer or on a two pairs of wheels mounted on adjacent axles similarly located.) and a jack shaft located at the forward hitch. To provide greater stability against rocking movement caused by motion of people inside the trailer, many prior travel trailers have used additional stabilizing jacks, typically positioned at the corners of the trailer and extending from the trailer to the ground.

Another trend in travel trailer manufacture has been to include a wide variety of appliances and entertainment devices within the trailer, “all the comforts of home,” sort to speak. Many of these items, however, function best when mounted or supported on a level surface. Also, some activities that users engage in within a trailer, such as cooking, are best done on level surfaces. In addition, many travel trailer users are more comfortable sleeping, sitting, and standing within the travel trailer when it forms a level platform, much like their usual abode. Unfortunately, campgrounds and the like where travel trailers are used cannot always provide a level parking surface for the trailer. Some prior motor homes have solved similar concerns by using corner leveling jacks mounted at the location of the stabilizing jacks previously used with travel trailers. However, due to the lighter frames and extensive use of slide outs and/or fold outs in travel trailers which already put cantilevered stress on travel trailer frames, such corner leveling jacks have been found to warp the frame of travel trailers, crack side walls, and actually jam movement of slide outs.

Accordingly, it is common to level travel trailers manually by ramps, wood or plastic boards, and the like placed under or abutting the wheels and/or hitch jack. The process of that leveling can often take half an hour or so, and typically needs to be accomplished by several front to back placements of the trailer itself, usually coordinated between a vehicle driver and leveling observer. At night or in inclement weather, such leveling can be excessively tedious and on occasion somewhat dangerous to the user. In addition, over time the travel trailer may shift on the ground or the ground settle somewhat beneath it, thereby changing the level status of the trailer. To re-level the trailer conventionally, a vehicle may need to be re-attached to the trailer or the trailer “man-handled” into new locations.

Therefore, an object of the present invention is to provide an improved method and apparatus for leveling travel trailers. Other objectives include provision of a method of leveling travel trailers which is:

a. relatively inexpensive,

b. reliable over long periods of use,

c. easy to establish by a single person both initially and subsequently,

d. not harmful to the trailer structure, and

e. readily incorporated into existing conventional trailer manufacturing methods.

These objectives of the present invention are met by the provision of a method of leveling travel trailers by placing a first pair of remotely operable jacks at the lower front corners of the trailer, placing a left and right pair of remotely operable jacks on each side of the trailer close to the axle hangers, mounting front to back and side to side level sensor on the trailer, and then operating the first pair of jacks to elevate the trailer when disconnecting the trailer from the towing vehicle and establishing a front to back level status by reference to the sensor output and then operating the left and/or right pair of jacks to establish a side to side level status by reference to the sensor output.

Other objects, advantages, and novel features of the present invention will be readily understood by those of skill in the art by reference to the following detailed description and attached drawings.

### BRIEF DESCRIPTION OF THE DRAWINGS

FIG. 1 shows a side plan view of the present invention as applied to a conventional travel trailer.

FIG. 2 shows a side plan view of the present invention as applied to a fifth wheel type of travel trailer.

FIG. 3 shows a front plan view of the trailer of FIG. 1.

### DETAILED DESCRIPTION OF PREFERRED EMBODIMENTS:

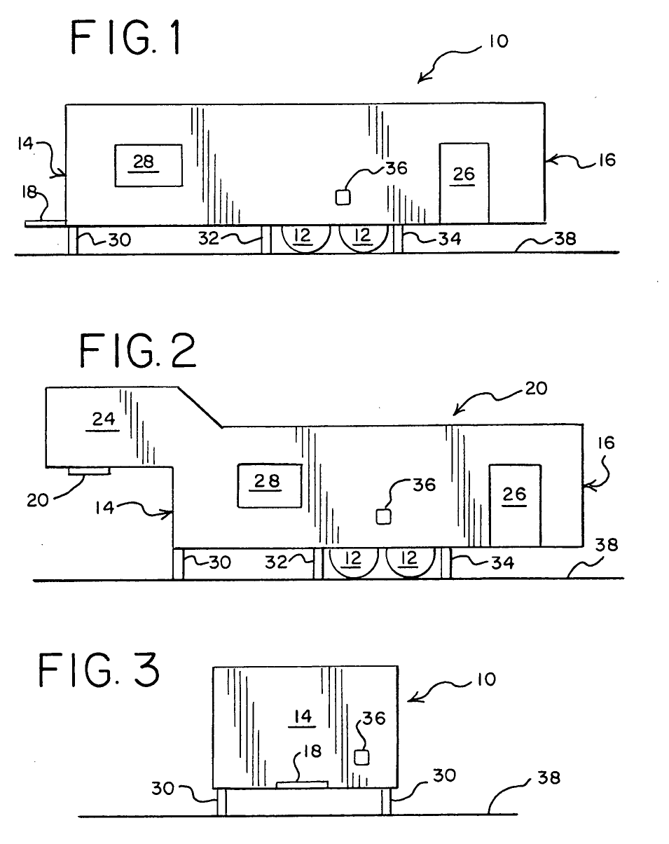

FIGS. 1 and 3 show a generic conventional travel trailer 10 having, for example, a generally rectangular configuration, with a pair of wheels 12 supported on two axles in a conventional manner on each side of the trailer. Trailers of a smaller size and/or lighter weight may use only a single axle structure, as is well known in the industry. Wheels 12 are mounted intermediate the front 14 of the trailer and the rear 16 of the trailer, according to conventional practice. As is typical for travel trailers, the hitch assembly 18 is located at the front of the trailer. The drawings are not to scale relative to each other.

FIG. 2 shows a generic fifth wheel type of travel trailer 20, with comparable components similarly numbered. In fifth wheels, the hitch 22 is usually of a different structure than those used in conventional travel trailers and is mounted under the front overhanging extension portion 24. That overhanging extension portion is, for example, cantilevered forward of the trailer body itself. Both trailers 10 and 20 may be equipt with whatever doors 26 and windows 28 are desired, according to conventional practice.

According to the present invention, a pair of jacks 30 are mounted at the lower front corners of trailers 10 or 20. These jacks can be of any suitable nature according to the size and/or weight of the trailer and the preferred operational systems in use by a given manufacturer, although for certain embodiments of the present invention it has been found to be particularly advantageous to use hydraulic jacks which can be remotely controlled from one or more convenient locations on the trailer. Jacks 30 are mounted to be retractable upwardly when the trailer is being towed so as to not interfere with necessary ground clearance and vehicle road travel. As shown in the figures, jacks 30 are extended downward to engage the ground surface 38 when the trailer is parked and ready for use.

Jacks 30 can be extended, preferably in tandem and simultaneously to engage the surface 38 to raise the front of the trailer to allow the towing vehicle to be positioned under hitches 18 or 20 when connecting the trailer and, similarly, raised to allow the hitch to be removed from the towing vehicle when disconnecting the trailer. This capacity of jacks 20 allows it to effectively replace a conventional hitch jack.

In the usual construction of travel trailers, wheels 12 are connected to the trailer by axles mounted on axle hangers secured in a conventional nature to the travel trailer frame. The point at which the axle hangers join the frame is often one of the strongest points of the frame construction and is often structurally reinforced over a limited length of the frame.

According to the present invention, another pair of jacks 32 are mounted forward of wheels 12 on each side of the trailer and toward the trailer front 14, preferably close to the forward axle hanger and within the portion of the frame which is structurally reinforced. A third pair of jacks 34 are similarly mounted rearward of wheels 12 on each side of the trailer and toward rear 16, preferably close to the rearward axle hanger and within the portion of the frame which is structurally reinforced. These jacks 32 and 34 are, for example, similar in construction to jacks 30.

One or more level sensors 36 of a conventional construction are mounted on the trailer to indicate front to back and/or side to slide level status. Sensor(s) 36 can be placed at any convenient location(s). It has been found to be advantageous in certain embodiments to have sensor 36 mounted near the jack controls. Sensor 36 provides a reference signal or output indication, such as a visual indicator, when the trailer is level from front to back and/or level from side to side.

During leveling operation once the towing vehicle and trailer are separated, jacks 30 can, for example, be raised or lowered as needed to create a front to back level status of the trailer, according to the output of sensor 36, regardless of the front to back inclination of surface 38. Thereafter, one set of jacks 32 and 34 on a given side of the trailer can be similarly raised or lowered as needed to create a side to side level status of the trailer according to the output of sensor 36, regardless of the side to side inclination of surface 38. Which side set of those jacks is selected for the leveling operation can be determined by the convenience of the user in a given instance, although in the usual case it is expected that only one side set need be employed for leveling at a given site.

According to various embodiments of the present invention, controls for each jack can be located adjacent the jacks themselves and/or at a centralized location inside or outside of the trailer. Similarly, sensor 36 can provide an output signal or indicia or level status at any or all of these jack control locations.

Although the present invention has been described in detail with respect to particular embodiments, this has been by way of illustration and example only. The present invention may be adapted as needed to particular embodiments which are not illustrated herein. Accordingly, the spirit and scope of the present invention are limited only by the following claims.

What is claimed is:

1. A method of leveling a travel trailer comprising the steps of:
providing a jacks at each of the front corners of the trailer body and adjacent each of the forward and rearward axle hangers,
providing a level sensor to the trailer body which indicates front to back and/or side to side level status of the trailer,
operationally controlling the jacks at the front corners of the trailer body to establish a front to back level status of the trailer according to the indication of the level sensor, and
operationally controlling the jacks which are adjacent the axle hangers on one side of the trailer to establish a side to side level status of the trailer according to the indication of the level sensor.

2. The method according to claim 1 also including the step of controlling the jacks at the front corners of the trailer body so as to facilitate attachment and detachment of the trailer hitch to a towing vehicle.

3. The method according to claim 2 also including the step of providing remote control of a plurality the jacks at a selected location of the trailer and providing an output indicia from the level sensor to that location.
